(19) United States
(12) Patent Application Publication
(10) Pub. No.: US 2002/0099136 A1
(43) Pub. Date: Jul. 25, 2002

(54) Polyamide composition with excellent gasoline resistance and impact resistance at a low temperature

(76) Inventors: Soo-Chul Park, Kyoungki-do (KR); Sang-Rok Lee, Kyoungki-do (KR); Hee-Won Seo, Ulsan (KR)

Correspondence Address: BIRCH STEWART KOLASCH & BIRCH, PO BOX 747, FALLS CHURCH, VA, 22040-0747, US

(21) Appl. No.: 09/972,965

(22) Filed: Oct. 10, 2001

(30) Foreign Application Priority Data
Nov. 30, 2000 (KR) 2000-72014

(51) Int. Cl. C08L 51/00

(52) U.S. Cl. 525/66; 525/178

(57) ABSTRACT

The present invention is related to a polyamide resin composition having an excellent gasoline resistance and impact resistance at a low temperature, and more particularly, to the polyamide resin composition comprising a general polyamide resin as an active ingredient; an impact modifier for dispersion such as EPM (ethylene/propylene) rubber, EPR (ethylene/propylene rubber) and EPDM (ethylene/propylene/diene) rubber; a plasticizer for providing flexibility such as lactams and sulfonamides; a thickener for uniform processability; and an ionomer for improving the appearance, elongation and impact strength, thus exhibiting advantages over conventional polyamide resins reinforced with an elastomer in excellent flexibility and appearance; superior gasoline resistance and impact resistance at a low temperature; better price as compared to its functions and thus enabling to be used in fuel tube systems of an automobile.

### BACKGROUND OF THE INVENTION

1. Field of the invention

The present invention is related to a polyamide resin composition having an excellent gasoline resistance and impact resistance at a low temperature, and more particularly, to the polyamide resin composition comprising a general polyamide resin as an active ingredient; an impact modifier for dispersion such as EPM(ethylene/propylene) rubber, EPR(ethylene/propylene rubber) and EPDM (ethylene/propylene/diene) rubber; a plasticizer for providing flexibility such as lactams and sulfonamides; a thickener for uniform processability; and an ionomer for improving the appearance, elongation and impact strength, thus exhibiting advantages over conventional polyamide resins reinforced with an elastomer in excellent flexibility and appearance; superior gasoline resistance and impact resistance at a low temperature; better price as compared to its functions and thus enabling to be used in fuel tube systems of an automobile.

2. Description of the Prior Art

Polyamide resins have been extensively used in a variety of fields such as interior and exterior parts of an automobile, electrical and electronic parts, sports goods, industrial materials, etc., due to their superiorities in mechanical strength, abrasion resistance, heat resistance, chemical resistance, insulation and arc resistance. However, their applications to interior tubes or hoses of an automobile have been restricted due to the drawbacks in compatibility with rubber, flexibility, viscosity and processability.

Polyamide resins reinforced with an elastomer have been used as a way to solve the above problems due to their superiorities in molding and flexibility, however, they are not recommended because of the relatively high price.

Methods to reinforce the polyamide resins by adding an elastomer to a given polyamide have been introduced to solve the above problems, for example, these methods disclose polyamide elastomers of polyoxytetramethylene glycol by substituting the rigid portion having carbon atoms of 4-19 among amide groups for elastomer (U.S. Pat. Nos. 4,230,838; 4,331,786; 4,332,920; and 4,207,40). However, using polyoxytetramethylene glycol to polyamide elastomers resulted in having an average molecular weight of 600-800 and they do not appear to have excellent flexibility nor toughness.

Another method to manufacture polyamide resin is to add EPR rubber, EPDM rubber, maleic anhydride grafted SEBS rubber (SEBS-g-MA). U.S. Pat. No. 5,919,865 discloses a high impact polyamide composition, U.S. Pat. No. 5,559,185 discloses thermoplastic resin composition, and U.S. Pat. No. 5,688,866 discloses impact modification of a thermoplastic resin.

U.S. Pat. Nos. 4,884,814, 5,120,791, 5,324,783 and 5,492,972 disclose polyamide resin manufactured by using ionomers and all these were used to manufacture golf balls.

U.S. Pat. Nos. 4,986,545, 5,120,791, 5,324,783 and 5,492,972 disclose the compatibilities between ionomers and other polymers or the miscible blendings, however, they were also used to manufacture golf balls. There are still other references, however, their uses are largely restricted to manufacturing golf balls and no prior art appears to teach the use in fuel tubes.

### SUMMARY OF THE INVENTION

As described above, the conventional polyamide resins have been improved in flexibilities and impact properties. However, they are not suitable to be used as a substance for fuel system of an automobile because of their poor appearance, ununiform thickness of parts, poor processability and difficulty in obtaining homogeneous polyamide resin compositions.

To solve the above problems in manufacturing polyamide resin compositions, the inventors of the present invention used a well dispersible rubber and a thickener to make a melt index less than 1.5 in addition to using the general polyamide resin as an active ingredient to obtain uniform processability and uniform thickness of the resulting parts. Further, the conditions of extrusion molding were also grafted in order to optimize the dispersion of the rubber being used. Still further, the inventors conducted experiments on various plasticizers to determine the optimal amount of each suitable plasticizer, prevented the whitening phenomenon that used to appear in parts by changing both the period and the temperature of drying, and added ionomers that can improve the appearance, elongation and impact properties thus completing the manufacturing of the polyamide resin composition having excellent low-temperature impact resistance and appearance as well as having equivalent or better flexibilities and workabilities as compared to the conventional polyamide resin compositions reinforced with elastomers.

Therefore, the object of the present invention is to prepare a very economical polyamide resin composition with a relatively low price wherein thus manufactured products have excellent appearance, gasoline-resistance, low-temperature impact resistance and flexibility.

### DETAILED DESCRIPTION OF THE INVENTION

The present invention is related to a polyamide resin composition which comprises:

(a) 50-95 parts by weight of polyamide resin;

(b) 1-45 parts by weight of at least one impact modifier selected from the group consisting of an EPM rubber, an EPR rubber, an EPDM rubber, a maleic anhydride grafted SEBS rubber (SEBS-g-MA), a maleic anhydride grafted EPR rubber (EPR-g-MA), a maleic anhydride grafted EPM rubber (EPM-g-MA), a maleic anhydride grafted EPDM rubber (EPDM-g-MA), and a core-shell type rubber;

(c) 0.1-20 parts by weight of at least one plasticizer selected from the group consisting of lactams and sulfonamides or a plasticizer selected from the group consisting of phthalate, adipate, phosphates and glycolates;

(d) 0.01-5 parts by weight of a thickener selected from the group consisting of multi-functional polymers and multi-functional oligomers, wherein each of said polymers comprises at least two unsaturated carboxylic acids and maleic anhydride at its ends;

(e) 0.5-10 parts by weight of an ionomer; and

(f) a flame-retardant, a reinforcing filler or a filler.

The present invention can be explained in more detail as described hereunder.

The present invention is related to a polyamide resin composition comprising adequate amounts of an impact modifier, a plasticizer, a thickener and an ionomer in addition to the polyamide resin as an active ingredient thereby showing excellent flexibility, plasticity, appearance and price being to equivalent or better than those of the conventional polyamide resin compositions reinforced with elastomers.

Each ingredient that constitutes the polyamide resin composition of the present invention is further explained as set forth below.

(A) Polyamide Resin

The polyamide resins of the present invention are the ones that are polymerized by condensation reaction between at least one of lactam(s) with higher than 3-membered ring and/or ω-amino acid(s), or between at least one of diacids and at least one of diamines. The polyamide resins prepared by polycondensation are polyamide polymers or copolymers. Moreover, the polyamide resin is selected from the group consisting of homopolyamides, copolyamides, and mixtures thereof and these polyamides are either semi-crystalline or non-crystalline.

Examples of monomers are 8-caprolactam, aminocapronic acid, enanthlactam, 7-aminoheptanoic acid, 11-aminoundecanoic acid, 9-aminononanoic acid and α-piperidone and more than one kind of these monomers are polymerized.

Examples of diacids include adipic acid, sebacic acid, dodecanedioic acid, glutaric acid, terephthalic acid, 2-methylterephthalic acid, isophthalic acid, naphthalenedicarboxlic acid, whereas examples of diamines include tetramethyldiamine, hexamethylenediamine, nonamethylendiamine, decamethylenediamine, undecamethylenediamine, dodecamethylenediamine, p-aminoaniline, and metaxylenediamine.

In addition to the above-mentioned diacids and diamines, polyfunctional compounds having more than three functional groups, such as trimellitic acid and pyromellitic acid, can be also used within the scope of less than 5 mole %.

Additionally, polyamides that can retain part of monomers of above-mentioned nylons can be also used to increase the flexibility and viscosity during polymerization.

Examples of polyamide resins used in the present invention include nylon 6, nylon 7, nylon 8, nylon 10, nylon 2, nylon 66, nylon 69, nylon 610, nylon 611, nylon 6T, nylon 6/66, nylon 6/12 and nylon 6/6T, and more 20 preferably nylon 6, nylon 66, nylon 6/66. Moreover, any combinational blends of these nylon resins with any mixed ratio can be also used.

The methods of polymerization are not restricted but can use any polymerization including anionic polymerization, mass melt polymerization, solution polymerization, salt-mediated melt polymerization, interfacial polymerization, and reaction extrusion, and copolymers that are polymerized by condensation reaction by using more than two kinds of monomers can be used regardless of the contents of the constituting ingredients.

In the present invention, it is possible to perform blending or copolymerization for the purposes of increasing weight, reinforcing, improving heat resistance and impact strength by using compounds selected from the group consisting of polyimides, polysulfones, polyether sulfones, polyphenylene sulfides, polyphenylene ether or polyphenylene oxide (PPO), high impact polystyrene (HIPS), acrylonitrile-butadiene-styrene copolymer (ABS copolymer), acrylonitrile-ethylenepropylene-styrene (AES copolymer) copolymer, acrylonitrile-styrene-allylacrylate (ASA), polycarbonates (PC), polyethyleneterephthaltes (PET) and polybutyleneterephthaltes (PBT). In addition, polyamides containing 5-20 parts by weight of various kinds of compatibilizer such as oxazoline grafted polystyrenes, maleic anhydride grafted polyolefins and the like can be also used to improve the functions of blends. These polyamide resins can be used 50-95 parts by weight to 100 parts by weight of the total polyamide resin composition.

(B) Impact Modifier

The present invention employs an impact modifier having impact strength of greater than 30 kg·cm/cm² at −40° C. to promote easier dispersion and the working condition of the extrusion can be adjusted to provide the optimal dispersion of rubber.

Examples of the impact modifiers are binary copolymers of ethylenepropylene such as EPM, EPR, EPDM, allylmethacrylate-butadiene-styrene (MBS), styrene-butadiene-styrene (SBS) triblock copolymer, maleic anhydride grafted EPM (EPM-g-MA), maleic anhydride grafted SBS (SBS-g-MA), maleic anhydride grafted EPDM (EPDM-g-MA), all-acrylic core-shell type rubber, ethyleneethylacrylate (EEA), styrenebutadiene rubber (SBR), ethylenevinylalcohol (EVOH), and various kinds of thermoplastic elastomers and plastomers. In addition, carboxylic acid or maleic anhydride can be also added to improve the impact strength. More preferred impact modifiers are EPM, EPDM, EPR, maleic anhydride grafted EPM, maleic anhydride grafted EPDM and maleic anhydride grafted EPR.

The present invention uses 0.1-25 parts by weight of a reaction monomer to 100 parts by weight of the total composition of a core-shell rubber, wherein said monomer is selected from the group consisting of maleic acid, maleic anhydride, mono- or diester of maleic acid, tert-butylacrylate, acrylic acid, glycidylacrylate and vinyl oxazoline.

The amount of the impact modifier used in the present invention is 1-45 parts by weight, and more preferably 10-35 parts by weight to the total polyamide resin composition.

(C) Plasticizer

The present invention employs a certain amount of a plasticizer in the polyamide resin composition to improve flexibility to be suitable for fuel tube system of an automobile. The plasticizers used in the present invention are versatile and are thus not limited to those lactams such as caprolactam and lauryl lactam or sulfonamides such as o,p-toluene sulfonamide and n-ethyl o,p-toluene sulfonamide.

Therefore, the plasticizer of the present invention can be selected from various polymers such as the above-mentioned sulfonamide plasticizers, trimellitate plasticizers, polymer type plasticizers, phthalate plasticizers, adpate plasticizers, phosphate plasticizers, glycolate plasticizers and a mixture thereof.

U.S. Pat. No. 4,197,379 discloses other useful plasticizers. The plasticizers in this reference are used 0.1-20 parts by weight to 100 parts by weight of polyamide resin composition, and more preferably 5-10 parts by weight

(D) Thickener

The increase in the kinds of plasticizers used in the polyamide resin composition results in the increase in the flexibility, however, this also makes the melt index of a given polyamide resin composition not suitable for the extrusion molding or blow molding. To solve this problem, the inventors of the present invention used an adequate amount of a thickener to provide the polyamide resin composition with a proper melt index.

Thickeners used in the present invention are selected from polymers and oligomers having multi-functional groups, wherein each of these polymers comprise at least two unsaturated carboxylic acids and maleic anhydride at its ends. Examples of these thickeners are styrene maleic anhydride resin (SMA) in the form of a maleic anhydride grafted polymer and grafted polyolefins and polymers with a similar reactive group. Besides, multi-functional epoxy resin such as cresol novolac epoxy and phenol novolac epoxy can be also used.

The thickener of the present invention is preferred 0.01-5 parts by weight to 100 parts by weight of the total polyamide resin composition, and more preferably 0.1-2 parts by weight

(E) Ionomer

The present invention employs an ionomer to improve the appearance of products as well as the properties of elongation and low-temperature impact resistance. Ionomers are polymers of (a) acidic groups such as a carboxylic acid, a sulfonic acid or a phosphonic acid; (b) basic groups such as a quarternary nitrogene; and (c) partially neutralized acids or bases having conjugated acids or bases. Negatively charged acid groups such as carboxylate or sulfonate are neutralized with positively charged bases such as metal ions and quarternary nitrogenes, while positively charged base groups such as quarternary nitrogene are neutralized with anions like halides, organic acids and organic halides. Here, said acidic or basic groups are converted into ionomers by copolymerization with acid or base monomers such as alkyl methacrylates having at least one copolymer of another type such as olefins, styrenes, and vinyl acetates. The preferred ionomer used in the present invention is a copolymer between (i) 70-90 parts by weight of an olefin copolymer having carboxylic acids neutralized with metal ions such as zinc, sodium, magnesium, or lithium; and (ii) 10-30 parts by weight of a methacrylic acid having 35-65 parts by weight of unsaturated carboxylic acids such as acrylic or methacrylic acid. SURLYN RTM 8140 is a commercial grade of an ionomer and SURLYN RTM AD 8546 is an ionomer neutralized by lithium. Ionomers are recommended to use 0.5-10 parts by weight, more preferably 0.5-5 parts by weight.

(F) Other Additives

One or more of other essential additives of fortifying or reinforcing fillers, fillers and diluents selected from the group consisting of oxidation stabilizers, light stabilizers, heat stabilizers, UV stabilizers, lubricants, release agents, pigments, dyes, flame retardants, fiber-fortifying fillers and nuclear agents can be added within the scope that do not affect the property, appearance and processability, i.e., 1-80 parts by weight to 100 parts by weight of the above resin composition.

Examples of oxidation stabilizers and heat stabilizers are a mixture of at least two selected from the group consisting of metal halogens such as sodium-, potassium-, lithium-, and copper-halogens; chloride, bromide, zinc, hindered phenols, various kinds of phosphorus and hydroquinones.

Examples of LW stabilizers are resorcinols, salicylates, hindered amines, benzotriazoles and benzophenols.

Examples of lubricants and release agents are stearic acid, stearine alcohol, stearamide, wax, carbonic esters, carbonic metallic salts. Examples of pigments are titanium dioxide, cadmium sulfide, cadmium selenite, ultra marine blue and carbon black, and the example of an organic dye is nigrosine.

Examples of flame retardants are organic halogens, non-halides and metal hydroxides.

The examples of fillers and fortifying fillers are glass fibers, glass beads, glass flakes, mica, talc, carbon fiber, kaolin, wollastonite, molybdenum sulfide, potassium titanate, barium sulfate, conductive carbon black and aramid fiber.

Besides, other additives such as fire retardant, anti-dripping agents, magnetic property donating agents, EMI masking agents, antibacterial agents, flavoring agent, metal inactivators, weathering stabilizer, anti-static agents may be arbitrarily incorporated.

In the present invention, the polyamide resin composition comprising the above-mentioned ingredients is mixed in a supermixer with other essential additives such as lubricants and stabilizers and injected product is finally obtained by using the conventional mixers such as a twin-screw extruder, a single-screw extruder, a roll-mill, a kneader and a bamburry mixer, and it is more preferred to obtain the product by melt-kneading using a twin-screw extruder without applying vacuum, obtaining pellets via a pelletizer followed by drying in a cold wind dryer.

The present invention is explained in more detail based on the following examples but they should not be construed as limiting the scope of this invention.

### EXAMPLES 1-11

The composition containing nylon 6, caprolactam, maleicanhydride grafted EPM rubber (EPM-g-MA), sulfonamide plasticizer (liquid phase), core-shell type rubber, thickener, carbon black master batch, wherein the constituting ingredients and the respective amount is shown in the following table 1, is mixed, dry-blended, and melt-kneaded at 240 ° C by using a twin-screw extruder, pelletizing by using a pelletizer and dried in a cold wind dryer set at 70° C. and 90° C., respectively, for predetermined periods of time. The prepared polyamide resin composition is performed for injection molding with changing the revolution speed of the screw after drying in a cold wind dryer set at 70 ° C for a predetermined period of time.

### COMPARATIVE EXAMPLE 1

Polyamide resin compositions reinforced with multi-valent elastomers were compared. Pellets were obtained by using a twin-screw extruder, dried in a cold wind dryer set at 70° C. for 5 hr and their general properties were examined (screw rpm 250).

### EXPERIMENTAL EXAMPLE 1

### General Properties

The samples obtained from the above Examples 1-11 and Comparative Example 1 were examined for their properties and the appearance according to the following methods and the standards. The dispersion level of the samples was observed under a light microscope after making the rubbers into thin films and the results are shown in the following table 1.

[Properties and Test Methods]

(1) Tensile Strength (kg/cm²) and Elongation (%): measured in accordance with ASTM D 638, 50 mm/min

(2) Flexural Strength (kg/cm²) and Modulus of bending elasticity (kg/cm²): measured in accordance with ASTM D 790, 10 mm/min

(3) Izod Impact Strength (kg·cm/cm²) at room temperature and at −40° C: measured in accordance with ASTM D 256, 1/4 inch thick samples, Izod Notched

(4) Melt Index (MI, g/10 min): measured in accordance with ASTM D-1238 (235° C., 2.16 kgf)

TABLE 1

| Classification | | | | | | | | | | | | |
|---|---|---|---|---|---|---|---|---|---|---|---|---|
| (parts by | Examples | | | | | | | | | | | *Com |
| weight) | 1 | 2 | 3 | 4 | 5 | 6 | 7 | 8 | 9 | 10 | 11 | Ex 1 |
| Nylon 6 | 59.8 | 59.3 | 55.8 | 53.3 | 54.3 | 51.8 | 54.8 | 52.8 | 58.2 | 55.5 | 57.8 | 68.0 |
| Caprolactam | 8.0 | 8.0 | 8.0 | 8.0 | 8.0 | 8.0 | 8.0 | 8.0 | 8.0 | 8.0 | 8.0 | — |
| EPDM-g-MA | 30.0 | 30.0 | 30.0 | 30.0 | 30.0 | 30.0 | 30.0 | 30.0 | 30.0 | 30.0 | 30.0 | — |
| Elastomer | — | — | — | — | — | — | — | — | — | — | — | 30.0 |
| Sulfonamide | — | 0.5 | 1.5 | 1.5 | 3.0 | 3.0 | 5.0 | 7.0 | 1.5 | 1.5 | 1.5 | — |
| plasticizer | | | | | | | | | | | | |
| Thickener | 0.2 | 0.2 | 0.2 | 0.2 | 0.2 | 0.2 | 0.2 | 0.2 | 0.3 | 0.5 | 0.7 | — |
| Ionomer | — | — | 2.5 | 5.0 | 2.5 | 5.0 | — | — | — | 2.5 | — | — |
| Carbon black | 2.0 | 2.0 | 2.0 | 2.0 | 2.0 | 2.0 | 2.0 | 2.0 | 2.0 | 2.0 | 2.0 | 2.0 |
| master batch | | | | | | | | | | | | |
| Property | | | | | | | | | | | | |
| Melt index | 0.5 | 0.7 | 1.0 | 0.8 | 1.5 | 1.1 | 3.2 | 4.3 | 1.3 | 0.8 | 0.6 | 1.1 |
| (g/10 min) | | | | | | | | | | | | |
| Tensile | 405 | 405 | 405 | 400 | 390 | 385 | 400 | 350 | 420 | 405 | 420 | 400 |
| strength | | | | | | | | | | | | |
| (kg/cm²) | | | | | | | | | | | | |
| Elongation | 235 | 245 | 280 | 290 | 285 | 300 | 265 | 270 | 220 | 255 | 205 | 280 |
| (%) | | | | | | | | | | | | |
| Flexural | 244 | 240 | 230 | 210 | 210 | 200 | 235 | 185 | 250 | 218 | 260 | 210 |
| strength | | | | | | | | | | | | |
| (kg/cm²) | | | | | | | | | | | | |
| Modulus | 6200 | 6000 | 5600 | 5100 | 5000 | 4600 | 4100 | 3600 | 5200 | 5000 | 6500 | 4750 |
| of bending | | | | | | | | | | | | |
| elasticity | | | | | | | | | | | | |
| (kg/cm²) | | | | | | | | | | | | |
| Impact | NB | NB | NB | NB | NB | NB | NB | NB | NB | NB | NB | NB |
| Strength | | | | | | | | | | | | |
| (23° C., | | | | | | | | | | | | |
| kg · cm/cm) | | | | | | | | | | | | |
| Impact | 19.0 | 21.8 | 25.2 | 27.6 | 25.0 | 28.3 | 22.3 | 22.9 | 20.1 | 24.6 | 18.5 | 19.5 |
| Strength | | | | | | | | | | | | |
| (−40° C., | | | | | | | | | | | | |
| kg · cm/cm) | | | | | | | | | | | | |
| Appearance | X | Δ | ◯ | ◯ | ◯ | ◯ | Δ | Δ | X | ◯ | X | Δ |
| Release of | ◯ | ◯ | ◯ | ◯ | Δ | Δ | X | X | ◯ | ◯ | ◯ | ◯ |
| Plasticizer | | | | | | | | | | | | |

*Com Ex. comparative example
◯: Excellent Dispersity, Clear appearance by naked eye
Δ: Minute rubber chunks are clustered, and minor projections are observed in the products by naked eye
X: There are many rubber chunks and they are large. Many minor projections are observed in the products by naked eye.
NB: No break

### EXPERIMENTAL EXAMPLE 2

### Duration of Drying in the Cold Wind Dryer and Physical Properties according to Drying Temperatures

Polyamide resin composition in example 4, wherein its physical properties are equivalent or better than those of the comparative example 1, as shown in the above table 1, was examined for the general physical properties and the release of a plasticizer according to the drying temperatures of a cold wind dryer and duration of drying. The results are shown in the following table 2 (screw rpm 250).

TABLE 2

| | *Ex 4, Cold Wind | | | **Com. Ex. 1, Cold | | |
|---|---|---|---|---|---|---|
| | Dryer (70° C.) | | | Wind Dryer (70° C.) | | |
| Classification | 3 hr | 5 hr | 9 hr | 3 hr | 5 hr | 9 hr |
| Melt index | 0.8 | 0.8 | 0.7 | 1.0 | 1.0 | 0.9 |
| (g/10 min) | | | | | | |
| Tensile | 410 | 430 | 445 | 405 | 387 | 460 |
| strength (kg/cm²) | | | | | | |
| Elongation (%) | 270 | 255 | 245 | 265 | 250 | 245 |
| Flexural strength | 218 | 238 | 255 | 210 | 235 | 271 |
| (kg/cm²) | | | | | | |
| Modulus of | 5150 | 5300 | 5700 | 4900 | 5250 | 5900 |
| bending elasticity | | | | | | |
| (kg/cm²) | | | | | | |
| Impact Strength | NB | NB | NB | NB | NB | NB |
| (23° C., kg · cm/cm) | | | | | | |
| Impact Strength | | | | | | |
| (−40° C., kg · cm/cm) | 26.2 | 26.0 | 25.4 | 18.7 | 18.5 | 18.4 |
| Release of | Δ | X | X | X | X | X |
| Plasticizer | | | | | | |

Ex.: example **Com. Ex.: comparative example
◯: Excellent Dispersity, Clear appearance by naked eye
Δ: Minute rubber chunks are clustered, and minor projections are observed in the products by naked eye
X: There are many rubber chunks and they are large. Many minor projections are observed in the products by naked eye.
NB: No break

### EXPERIMENTAL EXAMPLE 3

### Duration of Drying in the Cold Wind Dryer and Properties according to Drying Temperatures

Experiments were performed the same as in the above experimental example 2 with the exception that the cold wind dryer was set at 90° C. and the results are shown in the following table 3.

TABLE 3

| | *Ex 4, Cold Wind | | | **Com. Ex. 1, Cold | | |
|---|---|---|---|---|---|---|
| | Dryer (90° C.) | | | Wind Dryer (90° C.) | | |
| Classification | 3 hr | 5 hr | 9 hr | 3 hr | 5 hr | 9 hr |
| Melt index | 0.9 | 0.8 | 0.8 | 1.3 | 1.1 | 1.1 |
| (g/10 min) | | | | | | |
| Tensile | 398 | 400 | 405 | 390 | 400 | 430 |
| strength (kg/cm²) | | | | | | |
| Elongation (%) | 290 | 290 | 280 | 285 | 280 | 260 |
| Flexural strength | 205 | 210 | 212 | 198 | 210 | 225 |
| (kg/cm²) | | | | | | |
| Modulus of bending | 5080 | 5100 | 5110 | 4600 | 4750 | 5150 |
| elasticity (kg/cm²) | | | | | | |
| Impact Strength | NB | NB | NB | NB | NB | NB |
| (23° C., kg · cm/cm) | | | | | | |
| Impact Strength | 27.1 | 27.6 | 27.3 | 19.0 | 19.5 | 19.3 |
| (−40° C., kg · cm/cm) | | | | | | |
| Release of | ◯ | ◯ | Δ | ◯ | ◯ | Δ |
| Plasticizer | | | | | | |

### EXPERIMENTAL EXAMPLE 4

### Properties with Grafted Screw Revolution

For example 4 and experimental example 1, experiments were performed by modifying the screw revolution and samples were prepared in 0.05 mm films and observed the appearances under a light microscope and the results are shown in the following table 4 (cold wind dryer set at 70° C. for 5 hr).

TABLE 4

| | Ex. 4, Screw Revolution | | | Com. Ex. 1 |
|---|---|---|---|---|
| Classification | 150 | 250 | 350 | 1 |
| Melt index | 0.8 | 0.8 | 0.8 | 1.1 |
| (g/10 min) | | | | |
| Tensile strength | 400 | 400 | 400 | 390 |
| (kg/cm²) | | | | |
| Elongation (%) | 250 | 290 | 295 | 200 |
| Flexural strength | 220 | 210 | 210 | 210 |
| (kg/cm²) | | | | |
| Modulus of bending | 5200 | 5100 | 5000 | 4750 |
| elasticity (kg/cm²) | | | | |
| Impact Strength | NB | NB | NB | NB |
| (23° C., kg · cm/cm) | | | | |
| Impact Strength | 26.5 | 27.6 | 27.8 | 10.5 |
| (−40° C., kg · cm/cm) | | | | |
| Release of Plasticizer | X | Δ | ◯ | Δ |

### EXPERIMENTAL EXAMPLE 5

### Gasoline-Resistance Test

For example 4 and experimental example 1, samples were impregnated, and the properties and the whitening phenomenon were observed according to the following methods and the results are shown in the following table 5.

[Test Method of Gasoline Resistance]

(1) Impregnation in gasoline at 50° C. for 48 hr and 96 hr

(2) Flexural Strength (kg/cm²) and Modulus of bending elasticity (kg/cm²): measured in accordance with ASTM D 790 10 mm/min

(3) Evaluation of Appearance: Dispersion of rubber was evaluated by preparing samples collected by modifying the screw revolution into films of 0.05 m thick and observing the appearances under a light microscope and the appearances of the formed products were evaluated by the naked eye.

TABLE 5

| | Ex. 4 | | | Com. Ex. 1 | | |
|---|---|---|---|---|---|---|
| | | After | After | | After | After |
| Classification | *Immed. | 48 hr | 96 hr | *Immed. | 48 hr | 96 hr |
| Oil absorption | — | 0.14 | 0.17 | — | 0.12 | 0.15 |
| (%) | | | | | | |
| Flexural | 210 | 250 | 255 | 210 | 246 | 250 |
| strength | | | | | | |
| (kg/cm²) | | | | | | |
| Modulus of | 5100 | 5700 | 5750 | 4750 | 5550 | 5600 |
| bending elasticity | | | | | | |
| (kg/cm²) | | | | | | |
| Appearance | ◯ | ◯ | ◯ | Δ | Δ | Δ |
| Whitening | None | None | None | None | None | None |
| Phenomenon | | | | | | |

◯: Excellent Dispersity, Clear appearance by naked eye
Δ: Minute rubber chunks are clustered, and minor projections are observed in the products by naked eye.
X: There are many rubber chunks and they are large. Many minor projections are observed in the products by naked eye.
*Immed.: Immediately after injection

As described above, the polyamide resin composition of the present invention not only exhibits equivalent or better physical properties and appearance as compared to the conventional polyamide resin composition reinforced with elastomer but also shows excellent gasoline resistance, low-temperature impact resistance, appearance and elongation, thus having suitable flexibility for formed products such as tubes and also providing excellent polyamide resin composition with superior cost.

What is claimed is:

1. A polyamide resin composition having an excellent gasoline resistance and low temperature impact resistance, wherein said polyamide resin composition comprises:
(a) 50-95 parts by weight of a polyamide resin;
(b) 1-45 parts by weight of an impact modifier selected from the group consisting of an EPM rubber, an EPR rubber, an EPDM rubber, a maleic anhydride grafted SEBS rubber (SEBS-g-MA), a maleic anhydride grafted EPR rubber (EPR-g-MA), a maleic anhydride grafted EPM rubber (EPM-g-MA), a maleic anhydride grafted EPDM rubber (EPDM-g-MA), a core-shell type rubber, and a mixture thereof;
(c) 0.1-20 parts by weight of a plasticizer selected from the group consisting of lactams, sulfonamides, and a mixture thereof or one selected from the group consisting of phthalates, adipates, phosphates and glycolates;
(d) 0.01-5 parts by weight of a thickener selected from the group consisting of polymers and oligomers having multi-functional groups, wherein each of said polymers comprises at least two unsaturated carboxylic acids and maleic anhydrides at its ends;
(e) 0.5-10 parts by weight of an ionomer; and
(f) a flame-retardant, a reinforcing filler or a filler.

2. The polyamide resin composition according to claim 1, wherein said polyamide resin in (a) is selected from the group consisting of nylon 6, nylon 66, nylon 6/66 or a resin having amide groups in its structure.

3. The polyamide resin composition according to claim 1, wherein said polyamide resin comprises 5-20 parts by weight of a compound selected from the group consisting of acrylonitrile-ethylenepropylene-styrene (AES) copolymer, acrylonitrile-styrene-allylacrylate (ASA), polycarbonates and maleic anhydride grafted polyolefins.

4. The polyamide resin composition according to claim 1, wherein said impact modifier in (b) has the impact strength of greater than 30 kg·m/cm² at −40° C.

5. The polyamide resin composition according to claim 1, wherein said core-shell rubber in (b) comprises 0.1-25 parts by weight of a reaction monomer selected from the group consisting of maleic acid, maleic anhydride, mono- or diester of maleic acid, tert-butylacrylate, acrylic acid, glycidylacrylate and vinyloxazoline to the total composition of said core-shell rubber.

6. The polyamide resin composition according to claim 1, wherein said ionomer in (e) is the acid or basic polymer partially neutralized with cations or anions.

7. The polyamide resin composition according to claim 1, wherein said resin composition additionally comprises 2-50 parts by weight of flame retardant selected from the group consisting of organic halides, non-halides and metal hydroxides.

8. The polyamide resin composition according to claim 1, wherein said resin composition additionally comprises 1-80 parts by weight of a reinforcing filler or a filler to 100 parts by weight of the total composition.

9. The polyamide resin composition according to claim 8, wherein said fortifying filler or said filler is at selected from the group consisting of glass fibers, glass beads, glass flakes, mica, talc, carbon fiber, kaolin, wollastonite, molybdenum sulfide, potassium titanate, barium sulfate, conductive carbon black, aramid fiber, and a mixture thereof.
